(19) United States
(12) Patent Application Publication
(10) Pub. No.: US 2026/0100861 A1
(43) Pub. Date: Apr. 9, 2026

(54) VEHICLE OPTION EVALUATION DEVICE AND METHOD

(71) Applicants: Hyundai Motor Company, Seoul (KR); Kia Corporation, Seoul (KR)

(72) Inventors: Hye Ryun LEE, Hwaseong-Si (KR); Jeong Min LEE, Hwaseong-Si (KR); Hyun Kook KIM, Hwaseong-Si (KR); Seok Tae SON, Hwaseong-Si (KR); Jong Wun KIM, Hwaseong-Si (KR)

(21) Appl. No.: 19/314,181

(22) Filed: Aug. 29, 2025

(30) Foreign Application Priority Data
Oct. 4, 2024 (KR) 10-2024-0134945

(51) Int. Cl. H04L 12/40; B60W 50/00; B60W 50/14; H04L 67/12

(52) U.S. Cl. CPC H04L 12/40; B60W 50/14; H04L 67/12; B60W 2050/0045; H04L 2012/40215; H04L 2012/40273

(57) ABSTRACT

An apparatus for a vehicle may comprise a processor and a memory storing at least one instruction that, when executed by the processor communicating with the memory, is configured to cause the apparatus to store data structure information in the memory. The data structure information may comprise an option verification condition in a controller area network (CAN) protocol format, wherein the option verification condition is associated with at least one piece of option information about the vehicle. The apparatus may extract, from among CAN messages collected from the vehicle, a CAN message satisfying the option verification condition, output, based on the extracted CAN message and the data structure information, a signal comprising the at least one piece of option information, and control at least one function of the vehicle.

### CROSS-REFERENCE TO RELATED APPLICATION

This application claims benefit of priority Korean Patent Application No. 10-2024-0134945, filed on Oct. 4, 2024, the entire contents of which are incorporated herein by reference.

### TECHNICAL FIELD

Various examples of the present disclosure relate to techniques for more conveniently evaluating a vehicle option.

### BACKGROUND

The matters described in this Background section are only for enhancement of understanding of the background of the disclosure, and should not be taken as acknowledgment that they correspond to prior art already known to those skilled in the art.

In vehicles, various options are included depending on vehicle class, grade, and functions.

Vehicle development methods may be performed simply by creating product numbers based on the presence or absence of options and developing software to match the product numbers. For example, vehicles may be manufactured in a way that there are multiple copies of software for one vehicle controller.

Customized-order manufacturing may be carried out by a software-defined vehicle (SDV) method. For example, unlike hardware-centered vehicles, functions and performance of a vehicle may be defined and adjusted by software, so that new functions may be added or performance may be improved through software updates. In the SDV development method, a single large software may be applied and developed so that the software is operable according to the options of each vehicle.

When a function of a vehicle is evaluated, verification of the optional specifications of the vehicle may be performed. However, since verification of optional specifications may be done only by manually analyzing a memory (e.g., an electrically erasable programmable read-only memory (EEPROM)) of the vehicle, a more efficient and integrated evaluation method is considered for option evaluation in the SDV vehicle development method.

### SUMMARY

The present disclosure has been made to solve the aforementioned problems, and is directed to comprehensively evaluating vehicle options using a controller area network (CAN) message of a vehicle.

Problems to be solved by the present disclosure are not limited to those mentioned above, and other problems not mentioned will be clearly understood by those of ordinary skill in the art from the following description.

According to the present disclosure, an apparatus for a vehicle, the apparatus may comprise a processor, and, a memory storing at least one instruction that, when executed by the processor communicating with the memory, is configured to cause the apparatus to, store data structure information in the memory, wherein data structure information may comprise an option verification condition in a controller area network (CAN) protocol format, wherein the option verification condition is associated with at least one piece of option information about the vehicle, extract, from among CAN messages collected from the vehicle, a CAN message satisfying the option verification condition, output, based on the extracted CAN message and the data structure information, a signal may comprise the at least one piece of option information about the vehicle, and, control, based on whether the at least one piece of option information of the signal matches a configuration of the vehicle, at least one function of the vehicle.

The apparatus, wherein the data structure information has a structural configuration may comprise at least one of, region-specific option information about the vehicle, function-specific option information about the vehicle, or, vehicle class-specific option information about the vehicle. The apparatus, wherein the at least one instruction, when executed by the processor communicating with the memory, is configured to cause the apparatus to, receive, from a server, option information about the vehicle, compare the option information received from the server with the at least one piece of option information about the vehicle, wherein the at least one piece of option information is confirmed based on the extracted CAN message from the vehicle, and, verify, based on the comparison, whether the option information received from the server matches the at least one piece of option information about the vehicle.

The apparatus, wherein the at least one instruction, when executed by the processor communicating with the memory, is configured to cause the apparatus to, provide, based on the option information received from the server matching the at least one piece of option information about the vehicle, the option information received from the server to a user via a user interface of the vehicle. The apparatus, wherein the at least one instruction, when executed by the processor communicating with the memory, is configured to cause the apparatus to, based on the option information received from the server not matching the at least one piece of option information about the vehicle, determine that an error has occurred and provide a notification, to a user via a user interface of the vehicle, indicating the error. The apparatus, wherein the option verification condition corresponds to at least an air conditioning control system option.

According to the present disclosure, a method performed by an apparatus for a vehicle, the method may comprise collecting controller area network (CAN) messages from a vehicle, extracting, from among the CAN messages collected from the vehicle, a CAN message satisfying data structure information, wherein the data structure information may comprise an option verification condition associated with at least one piece of option information about the vehicle, outputting, based on the extracted CAN message and the data structure information, a signal may comprise the at least one piece of option information about the vehicle, and, controlling, based on whether the at least one piece of option information of the signal matches a configuration of the vehicle, at least one function of the vehicle.

The method, wherein the data structure information has a structural configuration may comprise at least one of, region-specific option information about the vehicle, function-specific option information about the vehicle, or, vehicle class-specific option information about the vehicle. The method may further comprise receiving, from a server, option information about the vehicle, comparing the option information received from the server with the at least one piece of option information about the vehicle, and, verifying, based on the comparing, whether the option information received from the server matches the at least one piece of option information about the vehicle.

The method may further comprise providing, based on the option information received from the server matching the at least one piece of option information about the vehicle, the option information received from the server to a user via a user interface of the vehicle. The method may further comprise based on the option information received from the server not matching the at least one piece of option information about the vehicle, determining that an error has occurred and providing a notification, to a user via a user interface of the vehicle, indicating the error. The method, wherein the option verification condition corresponds to at least an air conditioning control system option.

According to the present disclosure, a non-transitory computer-readable recording medium storing instructions that, when executed, cause, receiving controller area network (CAN) messages from a vehicle, extracting, from among the CAN messages received from the vehicle, a CAN message satisfying data structure information, wherein the data structure information may comprise an option verification condition associated with at least one piece of option information about the vehicle, and wherein the option verification condition is in a CAN protocol format, outputting, based on the extracted CAN message and the data structure information, a signal may comprise the at least one piece of option information about the vehicle, and, controlling, based on whether the at least one piece of option information of the signal matches a configuration of the vehicle, at least one function of the vehicle.

The non-transitory computer-readable recording medium, wherein the data structure information has a structural configuration may comprise at least one of, region-specific option information about the vehicle, function-specific option information about the vehicle, or, vehicle class-specific option information about the vehicle. The non-transitory computer-readable recording medium, wherein the instructions, when executed, cause, receiving, from a server, option information about the vehicle, comparing the option information received from the server with the at least one piece of option information about the vehicle, and, verifying, based on the comparing, whether the option information received from the server matches the at least one piece of option information about the vehicle.

The non-transitory computer-readable recording medium, wherein the instructions, when executed, cause, provide, based on the option information received from the server matching the at least one piece of option information about the vehicle, the option information received from the server to a user via a user interface of the vehicle. The non-transitory computer-readable recording medium, wherein the instructions, when executed, cause, based on the option information received from the server not matching the at least one piece of option information about the vehicle, determining that an error has occurred and providing a notification, to a user via a user interface of the vehicle, indicating the error. The non-transitory computer-readable recording medium, wherein the option verification condition corresponds to at least an air conditioning control system option.

According to the present disclosure, an apparatus for a vehicle, the apparatus may comprise a processor, and, a memory storing at least one instruction that, when executed by the processor communicating with the memory, is configured to cause the apparatus to, obtain a plurality of messages from the vehicle, extract, from among the plurality of obtained messages, a message satisfying data structure information indicating at least one option verification condition associated with the vehicle, determine, based on the extracted message, option information about the vehicle, receive, from a server, reference option information about the vehicle, output a signal indicating whether the determined option information matches the received reference option information, and, control, based on the signal, at least one function of the vehicle.

The apparatus, wherein the at least one instruction, when executed by the processor communicating with the memory, is configured to cause the apparatus to, identify a plurality of signals associated with the extracted message, and, determine, based on the data structure information and vehicle-specific configuration data received from the server, whether each of the identified plurality of signals corresponds to a valid vehicle option.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example of a vehicle option evaluation device according to an example;

FIG. 2 shows an exemplary vehicle option evaluation device according to the example;

FIG. 3 shows an example of a method of evaluating a vehicle option according to an example; and.

FIG. 4 shows an example of a specific method of evaluating a vehicle option according to an example.

FIG. 5 shows an example computing system (e.g., a computing device of a vehicle option evaluation device or any other apparatus).

### DETAILED DESCRIPTION

Hereinafter, preferred examples of the present disclosure will be described in detail with reference to the accompanying drawings.

However, the technical idea of the present disclosure is not limited to some examples to be described but may be implemented in various different forms, and within the scope of the technical idea of the present disclosure, one or more among components in the examples may be used by being selectively combined and substituted.

Further, unless specifically defined and described, terms used in the examples of the present disclosure (including technical and scientific terms) may be interpreted as meanings which are generally understood by those skilled in the art to which the present disclosure pertains, and commonly used terms such as terms defined in the dictionary may be interpreted in consideration of the contextual meaning of the related art.

The terms used in the examples of the present disclosure are for the purpose of describing the examples only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, in describing a component of examples of the present disclosure, terms such as first, second, A, B, (a), (b), etc., may be used.

These terms are only for distinguishing the component from other components, and the essence, sequence, or order of the component is not limited by the terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” of another component, the term “on (above) or under (below)” includes not only when two components are in direct contact with each other, but also when one or more of other components are formed or disposed between the two components. Further, when a component is described as being “on (above) or below (under),” the description may include the meanings of an upward direction and a downward direction based on one component.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of vehicle option verification) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of vehicle option verification) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of vehicle option verification) described herein. Minimum risk maneuver (MRM) operation(s) may also be controlled, for example, based on one or more features (e.g., features of vehicle option verification) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of vehicle option verification) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of vehicle option verification) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of vehicle option verification) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

In the various flowcharts of the present document, at least some of operations may be omitted or their order may be changed, and at least some of the various examples of the present document may be performed at specific points in each operation of the flowchart. The various flowcharts of the present document may be performed by at least one of a vehicle option evaluation device 100, a vehicle option evaluation module 110, a processor 120, and a computer program.

Hereinafter, examples will be described in detail with reference to the accompanying drawings, but identical or corresponding components are denoted by the same reference numerals regardless of figure numbers, and redundant descriptions thereof will be omitted.

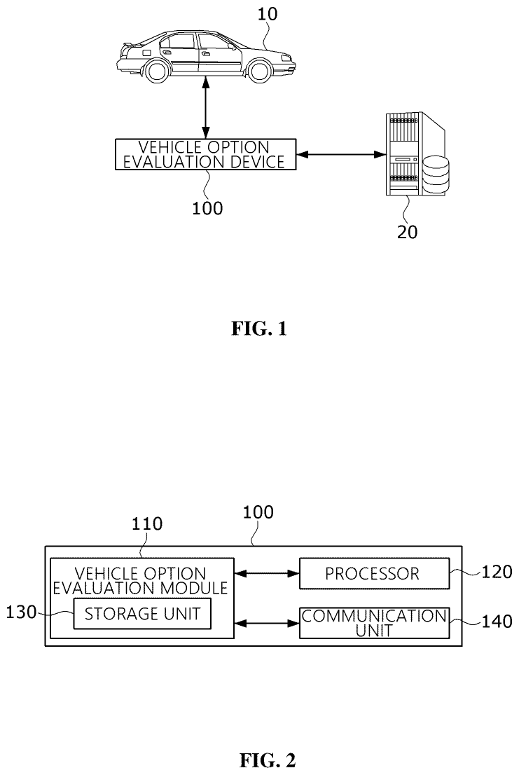

FIG. 1 is a conceptual view including a vehicle option evaluation device 100 according to an example.

The vehicle option evaluation device 100 performs a function of confirming and evaluating various options of a vehicle 10 based on a controller area network (CAN) message of the vehicle 10. The vehicle option evaluation device 100 may communicate with at least one of the vehicle 10 and a server 20 to transmit and receive data (e.g., CAN messages, configuration files, validation results, or firmware update instructions, etc.).

The vehicle option evaluation device 100 is illustrated as a separate device distinct from the vehicle 10 and the server 20, but according to various examples, the vehicle option evaluation device 100 may be configured to be included in the vehicle 10 or the server 20 (e.g., as an embedded ECU, a remote cloud module, or a mobile diagnostic tool, etc.).

The vehicle 10 may provide a CAN database (DB) including CAN messages to the vehicle option evaluation device 100. For example, the vehicle option evaluation device 100 may be connected to on-board diagnostics (OBD) port of the vehicle 10 by wire or wirelessly, and collect at least one CAN message from the vehicle 10 (e.g., a message from an HVAC controller, body control module, powertrain controller, or infotainment system, etc.).

The server 20 may provide basic specification information about the vehicle to the vehicle option evaluation device 100. The vehicle basic specification information may be information in which option information corresponding to the vehicle 10 is included (e.g., regional build configurations, model year feature packages, or customer-selected options, etc.). The vehicle basic specification information may be used to verify option analysis results confirmed by the vehicle option evaluation device 100, for example, in order to detect mismatches, missing configurations, or potential diagnostic errors more efficiently.

FIG. 2 shows an exemplary vehicle option evaluation device 100 according to the example.

According to one example, the vehicle option evaluation device 100 may include a vehicle option evaluation module 110, a processor 120, a storage unit 130, and a communication unit 140.

The vehicle option evaluation module 110 may be a software or hardware device that performs functions of the vehicle option evaluation device 100. For example, the vehicle option evaluation module 110 may include a recording medium that stores computer-readable instructions (e.g., logic for CAN message extraction, option verification algorithms, or diagnostic reporting routines, etc.). The vehicle option evaluation module 110 may include the storage unit 130, for example, for maintaining both static configuration data and dynamically collected CAN messages.

The storage unit 130 may store data generated in or collected from at least some of components of the vehicle option evaluation module 110 or the vehicle option evaluation device 100 (e.g., extracted CAN messages, parsed signal values, option evaluation results, or error logs, etc.). The storage unit 130 may include a memory configured to support both temporary data buffering and persistent storage of predefined evaluation structures. The storage unit 130 may be constituted by a combination of a non-volatile memory (e.g., a hard disk drive, a flash memory, an electrically erasable programmable read-only memory (EEPROM), a static RAM (SRAM), a ferro-electric RAM (FRAM), a phase-change RAM (PRAM), or a magnetic RAM (MRAM), etc.) and/or a volatile memory (e.g., a dynamic random access memory (DRAM), a synchronous dynamic random access memory (SDRAM), a double date rate-SDRAM (DDR-SDRAM), etc.).

The memory may include a specific data structure in which a vehicle option evaluation condition is predefined in a CAN protocol format (e.g., mapping signal bit positions to option types such as climate control mode, seat ventilation, or display type, etc.). For example, in the memory, an architecture for evaluating air conditioning control system options may be defined in the CAN protocol form (e.g., indicating whether the vehicle supports dual-zone HVAC, seat ventilation, or steering wheel heating, etc.). Through the predefined specific data structure, a CAN message related to a specific option of the vehicle 10 may be extracted from the CAN DB. In addition, the memory may include software capable of confirming and analyzing the CAN message of the vehicle 10 (e.g., to determine if an installed option matches the production specification or to trigger alerts in case of mismatches, etc.).

The CAN message is a protocol for communication between various electronic control units (ECUs) in the vehicle (e.g., a powertrain ECU, body control module, infotainment ECU, or HVAC controller, etc.). The CAN message may include components such as an identifier, a data length code, data, a checksum, and the like.

The CAN message is used for various communication functions such as function control, monitoring, error detection, and the like (e.g., reporting airbag status, managing door locks, or broadcasting sensor values, etc.), in the vehicle 10.

A CAN signal refers to an individual data field transmitted in a CAN message. Each signal contains specific information, and may include information such as the speed of the vehicle, a temperature sensor value, a blower level setting, or an active driving mode selection, etc.

The CAN signal may include a unique name that identifies the signal, a start position and length of bits that the signal occupies in the CAN message, units of the signal, and scale and offset information for converting the signal into an actual value.

The CAN signal as described above may be assigned a portion corresponding to a specific bit position of the CAN message. For example, the CAN signal may be mapped to a specific position in binary data of the CAN message (e.g., bit 0 indicating LCD presence, bit 1 indicating dual auto mode, or bit 2 indicating indirect vent function, etc.).

The processor 120 may be electrically connected to internal components of the vehicle option evaluation device 100, may electrically control each component, and may be an electrical circuit that executes software commands, thereby performing various data processing and calculations described below.

The processor 120 may process a signal transmitted between each component of the vehicle option evaluation device 100, and may perform overall control so that each component functions properly. The processor 120 may be implemented in the form of hardware, in the form of software, or in the form of a combination of hardware and software (e.g., as a microcontroller with embedded logic, a system-on-chip processor running a real-time OS, or a virtualized processor within a cloud module, etc.).

The communication unit 140 may communicate with the vehicle 10 or the server 20, for example, to exchange data related to vehicle configuration, option verification results, or software updates. The communication unit 140 may perform short range communication, global positioning system (GPS) signal reception, vehicle-to-everything (V2X) communication, optical communication, broadcast transmission and reception, and intelligent transport systems (ITS) communication functions e.g., for supporting cloud-based diagnostics, OTA provisioning, or real-time vehicle monitoring, etc.). The communication unit 140 may support short range communication using at least one of Bluetooth, radio frequency identification (RFID), Infrared Data Association (IrDA), ultra wideband (UWB), ZigBee, near field communication (NFC), Wireless-Fidelity (Wi-Fi), Wi-Fi Direct, and wireless Universal Serial Bus (wireless USB) technologies. The communication unit 140 may include a mobile communication module using a mobile communication network (e.g., LTE or 5G) and a wireless Internet module for wireless Internet access (e.g., for accessing remote configuration databases or firmware servers, etc.).

The communication unit 140 may be a module having software and hardware to support the CAN communication protocol of the vehicle 10, and may include a physical interface such as a connector for connection to the OBD port of the vehicle 10 (e.g., an OBD-II 16-pin connector or a dedicated diagnostic interface, etc.).

Although not illustrated in FIG. 2, the vehicle option evaluation device 100 may further include an input/output interface for input and output operations related to option evaluation, error alerts, or user-triggered diagnostics. The input/output interface may include an input device (e.g., physical keys, soft keys, or a touchscreen panel, etc.) and an output device (e.g., a display, a speaker, a haptic module, or indicator LEDs, etc.). The output device may include a display, and may further include an audio output device such as a speaker, and a haptic module that generates vibration (e.g., to alert the user of option mismatches or validation errors during inspection or maintenance, etc.).

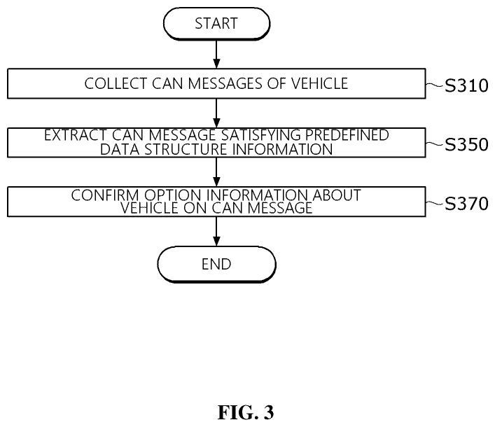

FIG. 3 shows an example of a method of evaluating a vehicle option according to an example.

The vehicle option evaluation device 100 may communicate with the vehicle 10 and receive a CAN message (S310). The vehicle option evaluation device 100 may collect a database including a CAN message or a plurality of CAN messages. The CAN database may include CAN messages collected from multiple controllers in the vehicle 10 (e.g., a body control module, HVAC controller, instrument cluster, or infotainment unit, etc.).

Next, the vehicle option evaluation device 100 may extract a CAN message satisfying preset data structure information (S350). For example, the vehicle option evaluation device 100 may confirm a CAN message that matches the preset data structure information in a list of the collected CAN messages, for example, by referencing bit-level signal definitions in a DBC file or similar format.

The data structure information is predefined by a user, and a vehicle option evaluation condition may have an architectural structure defined in a controller area network (CAN) protocol format (e.g., mapping specific byte positions to optional equipment signals such as display type, blower configuration, or indirect vent function, etc.).

According to one example, the predefined data structure information may include an architectural structure including at least one of region-specific option information, function-specific option information, and vehicle class-specific option information about the vehicle (e.g., distinguishing configurations for North America vs. Europe, premium vs. base trim levels, or sedan vs. SUV platforms, etc.).

The vehicle option evaluation device 100 may confirm the option information about the vehicle through the CAN message extracted based on the preset data structure information (e.g., by identifying whether specific bits within the message indicate the presence of features such as dual-zone HVAC, LCD control panels, or air purification modes, etc.) as above (S370). For example, the vehicle option evaluation device 100 may confirm an air conditioning control system option of the vehicle 10 by confirming the CAN message of the vehicle 10 (e.g., determining whether dual-zone climate control, steering wheel heating, or LCD-based control interfaces are present, etc.). In this case, the vehicle option evaluation device 100 may refer to CAN protocol-based data structure information predefined as contents related to the air conditioning control system option (e.g., signal mappings for blower type, LCD presence, automatic zone configuration, or indirect ventilation, etc.) so that the CAN message related to the air conditioning control system option is extracted accurately from the CAN database of the vehicle.

In addition, the vehicle option evaluation device 100 may confirm region-specific, function-specific, and vehicle class-specific air conditioning control options by referring to a predefined architecture (e.g., identifying configurations for LHD vs. RHD markets, base vs. premium climate packages, or compact vs. SUV models, etc.) so that region-specific information, function-specific information, and vehicle class-specific option information about the vehicle are extracted.

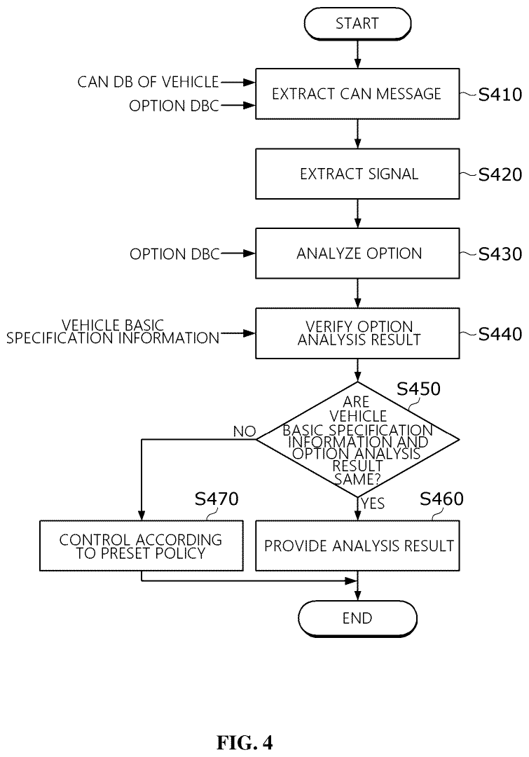

FIG. 4 shows an example of a specific method of evaluating a vehicle option according to an example. In contents in FIG. 4, the content overlapping the content in FIG. 3 may be omitted.

The vehicle option evaluation device 100 may extract or confirm a CAN message (S410).

Specifically, the vehicle option evaluation device 100 may extract at least one CAN message corresponding to an option DBC (database CAN) in a CAN DB of the vehicle using the CAN DB of the vehicle and a predefined data structure (e.g., option DBC) as input values (e.g., a DBC defining signals for blower mode, display type, or heater configuration, etc.).

For example, the vehicle option evaluation device 100 may derive a CAN message related to an air conditioning control system as an output value using an air conditioning control system option standardization DBC and the CAN DB as input values. To this end, the DBC for the option of the air conditioning control system may be defined by a user so that a signal may be defined for each byte of the CAN message, and may be applied to each vehicle type (e.g., different DBCs tailored for sedans, SUVs, or electric vehicles, etc.).

The vehicle option evaluation device 100 may extract a CAN signal from the CAN message (S420). For example, the vehicle option evaluation device 100 may derive a binary of each signal using the extracted CAN message as an input value. The vehicle option evaluation device 100 may confirm a CAN signal that is mapped and assigned to a specific bit of the CAN message (e.g., using signal start bit, length, scale, and offset defined in the DBC). For example, the vehicle option evaluation device 100 may separate signals for each byte of a CAN message extracted based on the standardization DBC of the air conditioning system (e.g., extracting Bit0 for blower configuration, Bit1 for dual auto mode, and Bit2 for LCD type, etc.).

The vehicle option evaluation device 100 may analyze the option of the vehicle 10 from the confirmed CAN signal (S430) (e.g., identifying whether the signal values satisfy expected configurations for a European premium trim vehicle, etc.).

The vehicle option evaluation device 100 may analyze the binary of the CAN signal to meet a defined option DBC condition (e.g., by matching expected bit values, ranges, or patterns specified in the DBC). For example, the vehicle option evaluation device 100 may derive a region-specific/function-specific/vehicle class-specific option analysis result according to each CAN signal as output values using the air conditioning control system option standardization DBC and a CAN signal file as input values (e.g., determining whether a Bit1 value of ‘1’ indicates dual auto mode for premium trims in European markets, or if Bit3 indicates an indirect ventilation function available only in high-end vehicle classes, etc.).

The vehicle option evaluation device 100 may verify the option analysis results based on the CAN message (S440), for example, by cross-checking the extracted signal values against predefined conditions in the DBC and expected vehicle configuration data (e.g., confirming that the presence of an LCD panel corresponds to an expected Bit2 value, or that blower type settings align with the regional build specification, etc.).

To this end, the vehicle option evaluation device 100 may receive basic specification information about the vehicle 10 from the server 20 (e.g., build sheet data, production manifest, or cloud-stored configuration profile, etc.). The basic specification information may include option information about the vehicle.

The vehicle option evaluation device 100 may compare the basic specification information about the vehicle 10 received from the server 20 or stored in the memory 130 with the option analysis result based on the CAN message described above to identify potential mismatches, missing configurations, or unexpected deviations. For example, the vehicle option evaluation device 100 may determine whether the option information included in the vehicle basic specification information and the option analysis result derived based on the CAN message match exactly or fall within an acceptable tolerance range, such as verifying the presence of dual-zone HVAC, LCD display type, or seat ventilation features, etc. (S450).

If the option information included in the vehicle basic specification information and the option analysis result derived based on the CAN message are the same (“YES” in S450), the vehicle option evaluation device 100 may provide an analysis result to the user (S460) (e.g., displaying a confirmation message, storing a verification log, or enabling software activation for validated features, etc.).

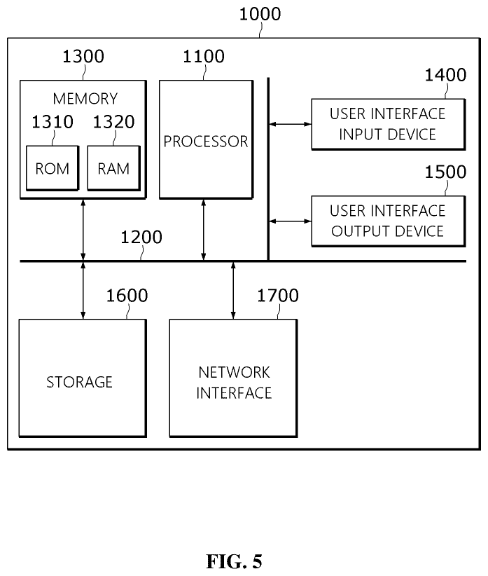

FIG. 5 shows an example computing system (e.g., a computing device of a vehicle option evaluation device or any other apparatus). One or more controllers, processors, etc. described herein, such as one or more components of the vehicle option evaluation device, one or more components of a vehicle, one or more components of a sever, and any other components and devices disclosed herein, may be implemented by or in the computing system as shown in FIG. 5.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an aspect of the present disclosure, there is provided a vehicle option evaluation device including a memory including data structure information in which a vehicle option evaluation condition is predefined in a controller area network (CAN) protocol format and a processor configured to extract a CAN message satisfying the data structure information from among CAN messages collected from a vehicle and confirm option information about the vehicle on the extracted CAN message based on the data structure information.

In some examples, the predefined data structure information may have an architecture structure including at least one of region-specific option information, function-specific option information, and vehicle class-specific option information about the vehicle.

In some examples, the processor may receive option information about the vehicle from a server, and compare the option information received from the server with the option information about the vehicle confirmed based on the CAN message of the vehicle to verify whether the two pieces of option information are the same.

In some examples, the processor may provide the option information to a user if the option information received from the server and the option information about the vehicle confirmed based on the CAN message of the vehicle are the same.

In some examples, the processor may determine that an error has occurred and provide a notification to the user if the option information received from the server and the option information about the vehicle confirmed based on the CAN message of the vehicle are not the same.

In some examples, the vehicle option evaluation condition may include at least an air conditioning control system option.

According to another aspect of the present disclosure, there is provided a method of evaluating a vehicle option by a vehicle option evaluation device including data structure information in which a vehicle option evaluation condition is predefined in a CAN protocol format, including collecting at least one CAN message from a vehicle, extracting a CAN message satisfying the data structure information from among the CAN messages of the vehicle, and confirming option information about the vehicle on the extracted CAN message based on the data structure information.

In the method according to some examples, the predefined data structure information may have an architecture structure including at least one of region-specific option information, function-specific option information, and vehicle class-specific option information about the vehicle.

The method according to some examples may further include receiving option information about the vehicle from a server and comparing the option information received from the server with the option information about the vehicle confirmed based on the CAN message of the vehicle to verify whether the two pieces of option information are the same.

The method according to some examples may further include providing the option information to a user if the option information received from the server and the option information about the vehicle confirmed based on the CAN message of the vehicle are the same.

The method according to some examples may further include determining that an error has occurred and providing a notification to the user if the option information received from the server and the option information about the vehicle confirmed based on the CAN message of the vehicle are not the same.

In the method according to some examples, the vehicle option evaluation condition may include at least an air conditioning control system option.

According to still another aspect of the present disclosure, there is provided a recording medium storing computer-readable instructions, including a memory including data structure information in which a vehicle option evaluation condition is predefined in a CAN protocol format, in which the memory stores instructions that, when executed, cause a processor connected to the memory to perform control to receive CAN messages of a vehicle from the vehicle, extract a CAN message satisfying the data structure information from among the CAN messages of the vehicle, and confirm option information about the vehicle on the extracted CAN message based on the data structure information.

In the recording medium according to some examples, the predefined data structure information may have an architecture structure including at least one of region-specific option information, function-specific option information, and vehicle class-specific option information about the vehicle.

The recording medium according to some examples may further include instructions for performing control to receive option information about the vehicle from a server, and compare the option information received from the server with the option information about the vehicle confirmed based on the CAN message of the vehicle to verify whether the two pieces of option information are the same.

The recording medium according to some examples may further include instructions for performing control to provide the option information to a user if the option information received from the server and the option information about the vehicle confirmed based on the CAN message of the vehicle are the same.

The recording medium according to some examples may further include instructions for performing control to determine that an error has occurred and provide a notification to the user if the option information received from the server and the option information about the vehicle confirmed based on the CAN message of the vehicle are not the same.

In the recording medium according to some examples, the vehicle option evaluation condition may include at least an air conditioning control system option.

For example, the vehicle option evaluation device 100 may output a message or signal indicating that the option analysis result is the same as the option information included in the vehicle basic specification information (e.g., displaying “Validation Passed” or activating a green indicator on a technician interface, etc.). In addition, the vehicle option evaluation device 100 may provide a final option analysis result to the user only if the option analysis result and the option information included in the vehicle basic specification information are the same to ensure accurate confirmation before enabling downstream operations such as feature activation or software updates.

If the option information included in the vehicle basic specification information and the option analysis result derived based on the CAN message are not the same (“NO” in S450), the vehicle option evaluation device 100 may be controlled according to a preset policy (S470) (e.g., blocking system updates, logging a diagnostic fault, or notifying a remote validation server, etc.).

For example, the vehicle option evaluation device 100 may provide the final option analysis result, but output a warning message indicating that the vehicle basic specification information and the option analysis result are not the same (e.g., “Discrepancy detected: Configured option missing or misreported”). As another example, the vehicle option evaluation device 100 may not provide the final option analysis result and instead halt the validation process or prompt for manual technician review since the vehicle basic specification information and the option analysis result are not the same.

According to one example, if the vehicle basic specification information and the option analysis result are not the same, the vehicle option evaluation device 100 may determine that an error has occurred and notify the user (e.g., via an alert message, visual warning, or error code display, etc.).

For example, if the vehicle basic specification information and the option analysis result are not the same, there may be cases where the defined option DBC needs to be modified (e.g., due to updates in vehicle architecture, new option variants, or incorrectly mapped signal definitions, etc.). In this case, the user may receive a notification that an error has occurred from the vehicle option evaluation device 100 through the input/output interface (e.g., a touchscreen display, speaker alert, or haptic vibration in a diagnostic tool, etc.). In this way, it may be confirmed that option specifications of the vehicle have changed, or error values or the like entered in the option evaluation in the vehicle option evaluation device 100 may be checked to ensure consistency with updated manufacturing or configuration records.

Through the examples described above, analysis and verification of the presence and type of options for each vehicle may be automatically performed by specific logic using only the CAN message information about the vehicle without requiring manual EEPROM inspection or labor-intensive physical validation.

According to an example of the present disclosure, vehicle options can be evaluated more simply and accurately by comprehensively evaluating vehicle options using a controller area network (CAN) message of a vehicle.

Effects of the present disclosure are not limited to those mentioned above, and other effects not mentioned will be clearly understood by those of ordinary skill in the art from the description below.

Although the preferred examples of the present disclosure have been described above, it is understood that those skilled in the art can make various changes and modifications to the present disclosure without departing from the spirit and scope of the present disclosure set forth in the claims below.

What is claimed is:

1. An apparatus for a vehicle, the apparatus comprising:
a processor; and
a memory storing at least one instruction that, when executed by the processor communicating with the memory, is configured to cause the apparatus to:
store data structure information in the memory, wherein data structure information comprises an option verification condition in a controller area network (CAN) protocol format, wherein the option verification condition is associated with at least one piece of option information about the vehicle,
extract, from among CAN messages collected from the vehicle, a CAN message satisfying the option verification condition, and
output, based on the extracted CAN message and the data structure information, a signal comprising the at least one piece of option information about the vehicle.

2. The apparatus of claim 1, wherein the data structure information has a structural configuration comprising at least one of:
region-specific option information about the vehicle,
function-specific option information about the vehicle, or
vehicle class-specific option information about the vehicle.

3. The apparatus of claim 1, wherein the at least one instruction, when executed by the processor communicating with the memory, is configured to cause the apparatus to:
receive, from a server, option information about the vehicle,
compare the option information received from the server with the at least one piece of option information about the vehicle, wherein the at least one piece of option information is confirmed based on the extracted CAN message from the vehicle, and
verify, based on the comparison, whether the option information received from the server matches the at least one piece of option information about the vehicle.

4. The apparatus of claim 3, wherein the at least one instruction, when executed by the processor communicating with the memory, is configured to cause the apparatus to:
provide, based on the option information received from the server matching the at least one piece of option information about the vehicle, the option information received from the server to a user via a user interface of the vehicle.

5. The apparatus of claim 3, wherein the at least one instruction, when executed by the processor communicating with the memory, is configured to cause the apparatus to:
based on the option information received from the server not matching the at least one piece of option information about the vehicle, determine that an error has occurred and provide a notification, to a user via a user interface of the vehicle, indicating the error.

6. The apparatus of claim 1, wherein the option verification condition corresponds to at least an air conditioning control system option.

7. A method performed by an apparatus for a vehicle, the method comprising:
collecting controller area network (CAN) messages from a vehicle;
extracting, from among the CAN messages collected from the vehicle, a CAN message satisfying data structure information, wherein the data structure information comprises an option verification condition associated with at least one piece of option information about the vehicle; and
outputting, based on the extracted CAN message and the data structure information, a signal comprising the at least one piece of option information about the vehicle.

8. The method of claim 7, wherein the data structure information has a structural configuration comprising at least one of:
region-specific option information about the vehicle,
function-specific option information about the vehicle, or
vehicle class-specific option information about the vehicle.

9. The method of claim 7, further comprising:
receiving, from a server, option information about the vehicle;
comparing the option information received from the server with the at least one piece of option information about the vehicle; and
verifying, based on the comparing, whether the option information received from the server matches the at least one piece of option information about the vehicle.

10. The method of claim 9, further comprising:
providing, based on the option information received from the server matching the at least one piece of option information about the vehicle, the option information received from the server to a user via a user interface of the vehicle.

11. The method of claim 9, further comprising:
based on the option information received from the server not matching the at least one piece of option information about the vehicle, determining that an error has occurred and providing a notification, to a user via a user interface of the vehicle, indicating the error.

12. The method of claim 7, wherein the option verification condition corresponds to at least an air conditioning control system option.

13. A non-transitory computer-readable recording medium storing instructions that, when executed, cause:
receiving controller area network (CAN) messages from a vehicle;
extracting, from among the CAN messages received from the vehicle, a CAN message satisfying data structure information, wherein the data structure information comprises an option verification condition associated with at least one piece of option information about the vehicle, and wherein the option verification condition is in a CAN protocol format; and
outputting, based on the extracted CAN message and the data structure information, a signal comprising the at least one piece of option information about the vehicle.

14. The non-transitory computer-readable recording medium of claim 13, wherein the data structure information has a structural configuration comprising at least one of:
region-specific option information about the vehicle,
function-specific option information about the vehicle, or
vehicle class-specific option information about the vehicle.

15. The non-transitory computer-readable recording medium of claim 13, wherein the instructions, when executed, cause:
receiving, from a server, option information about the vehicle;
comparing the option information received from the server with the at least one piece of option information about the vehicle; and
verifying, based on the comparing, whether the option information received from the server matches the at least one piece of option information about the vehicle.

16. The non-transitory computer-readable recording medium of claim 15, wherein the instructions, when executed, cause:
provide, based on the option information received from the server matching the at least one piece of option information about the vehicle, the option information received from the server to a user via a user interface of the vehicle.

17. The non-transitory computer-readable recording medium of claim 15, wherein the instructions, when executed, cause:
based on the option information received from the server not matching the at least one piece of option information about the vehicle, determining that an error has occurred and providing a notification, to a user via a user interface of the vehicle, indicating the error.

18. The non-transitory computer-readable recording medium of claim 13, wherein the option verification condition corresponds to at least an air conditioning control system option.
